(19) United States
(12) Patent Application Publication
(10) Pub. No.: US 2025/0361133 A1
(43) Pub. Date: Nov. 27, 2025

(54) METHOD AND COLLISION CLASSIFICATION SYSTEM FOR CLASSIFYING A COLLISION EVENT ON A RACKING SYSTEM

(71) Applicant: Jungheinrich AG, Hamburg (DE)

(72) Inventors: Benjamin BRUSS, Hamburg (DE); Ralf WETEGROVE, Norderstedt (DE)

(73) Assignee: Jungheinrich AG, Hamburg (DE)

(21) Appl. No.: 19/217,353

(22) Filed: May 23, 2025

(30) Foreign Application Priority Data
May 23, 2024 (DE) 10 2024 114 515.3

(51) Int. Cl. B66F 17/00; B66F 9/075; G06Q 10/08

(52) U.S. Cl. CPC B66F 17/003; B66F 9/0755; G06Q 10/08

(57) ABSTRACT

A method of classifying a collision event on a racking system including: detecting the collision event between an industrial truck and the racking system using a sensor on the racking system and determining a strength of the collision event, comparing the strength with a reference strength and emitting a collision signal if the determined strength exceeds the reference strength; transmitting the collision signal to a receiver of the industrial truck and forwarding the collision signal to a controller of the industrial truck, classifying the collision event as a function of status data of the industrial truck and of the collision signal. The classifying of the collision event comprises assigning a collision type from a collision type list, including at least one collision type for which the collision event is not assigned to the industrial truck and for which the collision event is assigned to the industrial truck.

### CROSS-REFERENCE TO RELATED APPLICATION

The present application is based upon and claims the benefit of priority from DE 10 2024 114 515.3 filed on May 23, 2024, the entire contents of each of which is incorporated herein by reference.

### BACKGROUND

### Field

The present disclosure relates to a method for classifying a collision event on a racking system and a collision classification system for classifying a collision event on a racking system.

### Prior Art

Racking systems are usually used in storage and logistics facilities where, for example, industrial trucks are used to load and unload the racking systems. There is a risk here, for example due to incorrect operation, that an industrial truck collides with a rack and causes a collision event.

In the field of application of industrial trucks, racking uprights are a particularly sensitive part of an upright rack, as they carry the entire load of the rack by design. Damage to racking uprights, for example when they are hit by an industrial truck, can lead to the rack tipping over or collapsing, putting people and goods at risk.

DE 10 2020 127 745 A1 discloses a collision warning system, wherein the system comprises at least one industrial truck and at least one collision detection device. The collision warning device has a mounting unit, a shock-sensitive sensor unit, a data processing unit and a transmitter unit, wherein the sensor unit can be attached by means of the mounting unit to a racking system to be monitored for collisions. The sensor unit is designed to measure a momentum transferred from the industrial truck to the racking system and the data processing unit compares the measured momentum with a reference momentum and, if the reference momentum is exceeded, triggers the transmitter unit to transmit a collision signal. In the event of a collision, for example, a warning is triggered directly on the industrial truck so that the operator involved can react.

In particular, operation of a collision warning system with a battery is envisaged, whereby, for example, the battery powers the data processing and transmission unit on the racking system as required. In the case of battery operation, the batteries must be replaced in regular intervals as part of maintenance depending on the operating time.

EP 2 483 120 B1 discloses a method for monitoring the operation of a vehicle comprising the following steps: detecting that an application of force to the vehicle has occurred; calculating a change in momentum of the vehicle; determining whether the change in momentum and the application of force occur within a predetermined time period; and generating an impact signal indicating that the change in momentum and the application of force have occurred within the predetermined time period. For example, for detecting a force impact, a g-force signal is generated by an accelerometer attached to a material handling vehicle and compared to a selectable g-force threshold. Among other things, an impact signal is only generated if the g-force signal is greater than the selectable g-force limit threshold value.

In the case of collision monitoring, in which the exceeding of limit values such as a g-force and/or an impulse is checked, some common storage processes unintentionally trigger a collision alarm. The difficulty in defining limit values is that a single limit value is predetermined for all possible collision types, even though higher but harmless forces may occur during a storage process than during a dangerous collision between a vehicle and a racking upright. False alarms and their verification represent an impairment of the operation of a storage facility.

This results in the task of reliably and precisely warning of collision events on a racking system with low maintenance and resource requirements.

### SUMMARY

The task can be solved by a method for classifying a collision event on a racking system, comprising: a sensor unit arranged on a racking system detects a collision event between an industrial truck and the racking system and determines a strength of the collision event, compares the determined strength with a reference strength and emits a collision signal associated with the collision event if the determined strength exceeds the reference strength; a receiver unit of an industrial truck receives the collision signal and forwards it to a control unit of the industrial truck, which performs a classification of the collision event as a function of status data of the industrial truck and of the collision signal, wherein the classification of the collision event comprises assigning a collision type from a collision type list, wherein the collision type list comprises at least one collision type for which the collision event is not assigned to the industrial truck and at least one collision type for which the collision event is assigned to the industrial truck.

A collision event is characterized and classified by a combination of a collision event strength determined on the racking system, and status data, for example movement data, of an industrial truck, whereby the characterization and classification of the collision event takes place in the industrial truck. The analysis of the collision event as well as the classification in the industrial truck allows several technical advantages.

For example, the energy consumption of the sensor unit on the racking system can be very low, as only a simple comparison with a predetermined reference strength can be provided. A more complex analysis takes place in the industrial truck, whose battery life is not affected by the analysis.

As another example, a simple analysis of the strength of the collision event in the sensor unit alone would not allow classification of the collision event and assignment of a collision type. For example, the approach of a rack by an industrial truck or the storage of a pallet in a rack can represent different types of collisions. Both events cause vibrations in a racking system, which can be detected as a collision event by a sensor unit. Here, the classification of collision events offers a versatile, customizable tool for making subsequent decisions, such as suitable measures following a collision.

By classifying collision events depending on both the collision signal and the status data of the industrial truck, the collision events can be specifically characterized. This can enable a reliable and precise warning of collision events, for example as a warning for a user of an industrial truck.

At least one collision type from the collision type list can be a collision type for which the collision event is not assigned to the industrial truck. This type can be assigned to the collision event, such as, if the analysis of the industrial truck shows that the industrial truck is not responsible for the collision event. For example, an industrial truck that moves continuously at a speed greater than a predetermined maneuvering speed before and after the collision event in a time window in which the time of the collision event lies is most likely not responsible for a collision event.

At least one collision type can represent a collision in which the analyzing industrial truck was involved, so that the industrial truck itself can be inspected in the simplest form, for example. At least two collision types from the collision list can be different collision types for which the collision event is assigned to the industrial truck. This can enable further refinement of the detection of different types of collision events. For example, driving collisions, i.e., collisions that occur when a rack is impacted, i.e., bumped into during travel, and storage collisions that occur when a load is stored in or retrieved from a rack, can be captured in two different collision types.

A storage collision can occur when forks of an industrial truck rest on a shelf when a load is stored in a shelf or a load carried on the forks is set down on the shelf of the racking system. Other types of collision can include, for example, a collision with the forks of the industrial truck and/or a collision with the load wheel arms of the industrial truck and/or a collision with the rear of an industrial truck. In addition, exemplary collision types for a storage collision can be the storage of a load at a predetermined height and/or a collision with a cross member of the racking system due to an insufficiently raised load. Furthermore, in embodiments, different collision types can be provided for different intensities of collision events, e.g., a driving collision with a rack with low, medium and/or high intensity.

The assignment of a collision type can comprise determining at least one collision type probability, which can indicates a probability that the collision event can be unambiguously assigned to a specific collision type, wherein a separate collision type probability can be determined for each collision type. This can ensure reliable classification of the collision event.

The question of which type of collision has occurred cannot be answered with certainty in every collision case. For example, a vehicle not involved in a collision may itself be performing driving or loading maneuvers at the time of the collision and may receive shock signals which, due to coincidence, result in a collision probability of greater than zero. On the other hand, an industrial truck can, for example, touch an object protruding irregularly from a storage rack when traveling from one location to another. Such a touch would hardly leave a signal on the industrial truck. If the object subsequently falls over, this can lead to a collision signal being emitted. In such a case, the industrial truck may have its proximity to the affected storage rack as the strongest signal and not very high probabilities for various specific collision types. For such cases, which are difficult to evaluate, a further category of collision types may be or have been created.

In embodiments, the classification can comprise a comparison of several collision type probabilities, wherein the collision type with the highest collision type probability can be indicated as the result of the classification. Alternatively or additionally, when selecting the collision type to be output, a predetermined lower limit for the collision type probability may be used, for example 60% or more, 75% or more, or 90% or more.

For a comparison of collision type probabilities, a sum of several collision type probabilities can be compared with at least one other collision type probability. For example, the sum of the collision type probabilities of collision types for which the collision is assigned to the industrial truck can be compared with the sum of the collision types for which the collision is not assigned to the industrial truck in order to classify the collision event.

A high quality of the classification of the collision event can be made possible by the status data of the industrial truck comprising a driving speed of the industrial truck and/or a lifting speed of the industrial truck and/or an acceleration measured by an acceleration sensor mounted on the industrial truck. Furthermore, in embodiments, the status data can comprise a rotational angular velocity of the industrial truck. For example, a driving speed of the industrial truck can be measured by odometry.

A precise classification of the collision event can be further improved if the status data is or are recorded in a time window and the time window comprises the time of the collision event as well as a time period before and/or after the time of the collision event. In embodiments, the status data of the industrial truck can be instantaneous status data at the time of the collision event. In other embodiments, this status data can also comprise status data from a time window containing the time of the collision event. Additional conditions and/or analyses for the classification are possible using this additional information. For example, for classification purposes, it can be checked whether the direction of travel, i.e., the direction of the travel speed, of the industrial truck changed, such as reversed, between a period before and a period after the collision event.

An industrial truck status can be determined for the classification of the collision event at the time of the collision event as a function of the status data, whereby the at least one collision type probability and/or the assigned collision type can be determined as a function of the determined industrial truck status. The additional determination of an industrial truck status enables the movement and/or position of the industrial truck to be evaluated, which is the basis, for example, for further classification of the collision event into a collision type. Possible industrial truck statuses are, for example, and not exhaustively, empty run, loaded run, maneuvering run, lifting movement, standstill or idle status. In embodiments, exactly one industrial truck status can be assigned to an industrial truck at any one time. In other embodiments, at least one industrial truck status can be assigned to an industrial truck at a point in time.

Further information can be obtained from the classification of the collision event if the assignment of a collision type has at least two successive steps, wherein in a first step, such as by at least a first collision type probability, it can be determined whether the collision event is assigned to the industrial truck, and in a second step, such as by at least a second collision type probability, a collision type can be assigned to the collision event. In addition, a two-step process can increase the efficiency of the process because a classification between different collision types, in each of which the industrial truck is assigned as the cause, does not have to be carried out because the industrial truck has already been excluded as the cause in a first step.

A reliable method of determining the strength of the collision event can be provided if a directly measured or derived physical or composite quantity is used as the determined strength of the collision event, such as a maximum acceleration and/or amplitude measured by an acceleration sensor, a momentum transfer and/or energy transfer. This variable can be an indicator of how strongly the racking system is affected by the collision event. The sensor unit can compare the determined strength of the collision event with at least two reference strengths. The collision event can be pre-classified by the comparison with different reference strengths. For example, collision events that exceed several reference strengths can be prioritized by an industrial truck compared to a collision event whose strength only exceeds one reference strength. Collision events with a higher priority can be classified before collision events with a lower priority, which can be used, for example, if an industrial truck receives collision signals from several sensor units at the same time or at close temporal intervals. In one embodiment, collision events that exceed several reference strengths can be classified using more resources, for example more computing time

A precise classification of the collision event can also be made possible if the collision signal comprises the determined strength of the collision event and/or a time series of measurement data recorded by the sensor unit for determining the strength of the collision event, such as a time series of accelerations of the collision event, wherein the time series can contain the time of the collision event, wherein, the strength of the collision event and/or the time series of measurement data can be evaluated for classifying the collision event. If the collision signal contains additional information about the collision event, such as the determined strength of the collision event and/or measurement data from which the strength of the collision event was determined, these can be available for analysis in the industrial truck. In combination with the status data of the industrial truck, this can improve the classification of the collision event. The collision signal can comprise a reference strength or the at least two reference strengths.

A time series of measurement data for determining the strength of the collision event can be a time series of accelerations of the collision event. A time series of accelerations can be measured by an acceleration sensor. The sensor unit can be configured to measure the amount of an acceleration by an acceleration sensor.

If a time series of measurement data is evaluated to classify the collision event, for example, to evaluate the time series of measurement data for vibration frequencies. For example, vibration frequencies can be detected in a time series of accelerations of the collision event. At least one collision event type can have a characteristic natural vibration spectrum, whereby the detected vibration frequencies can be compared with at least one predetermined natural vibration spectrum assigned to a collision type in order to classify the collision event. For example, high frequency vibrations are to be expected when shelves are excited to vibrate by vertical movement of forks, while low frequencies are to be expected when an entire racking system oscillates, for example due to a driving collision with a body of the industrial truck.

In order to provide the user with increased ease of use and a quick overview of the collision event, such as for managers of racking systems with a large number of collision events, the classification of the collision event can comprise a determination of a shock level of the collision event as an indicator of the intensity of the impact on the integrity of the racking system. In addition to the classification type, a collision event can be classified with a shock level. The shock level can be, for example, “low”, “medium” or “high”. A shock level can also be referred to as a shock rating. In one embodiment, the shock level can be determined directly exclusively from the strength of the collision event, whereby a classification of the strength into different levels can correspond to the classification into different shock levels. In another embodiment, the shock level can be determined as a function of the strength of the collision event and/or a time series of measurement data recorded by the sensor unit to determine the strength of the collision event and at least one other variable. A collision type can also be included to determine the shock level. In an embodiment in which a maximum acceleration value is used as the strength of the collision event, a collision event classified as a driving collision, for example, can be assessed with a high shock level even at a lower strength, because this can potentially result in a high risk to the integrity of the racking system, and a collision event with the same strength classified as a storage collision can be assessed at a low or medium shock level.

The shock level can be communicated to a user of the industrial truck responsible for the collision, such as with the industrial truck in embodiments displaying a warning including the shock level.

Furthermore, an exact determination of the one responsible can be provided by the classification of the collision event if the receiver unit determines a signal strength of the collision signal and if the signal strength is evaluated for the classification of the collision event, wherein, a collision type probability can be determined to be greater, the greater the signal strength.

The collision signal can be transmitted wirelessly from the sensor unit to the receiver unit, such as via Bluetooth Low Energy. The collision signal can be a broadcast event signal, which can be transmitted by the sensor unit without a specific receiver. The signal strength can be a radio signal strength and/or an RSSI value of a wireless communication link. If several industrial trucks receive the collision signal from the sensor unit, it is possible to determine which of the several industrial trucks has the smallest distance to the sensor unit by comparing the signal strengths determined by the respective industrial truck. One of the reasons for this is that the signal strength decreases as the distance between the transmitter and receiver increases.

When several industrial trucks are used in the vicinity of the racking system, classification can be more efficient if at least two industrial trucks receive the collision signal by a receiver unit each and, depending on the respective status data, each determine an industrial truck status and/or at least one collision type probability and transmit it to a warehouse management system together with the collision signal or their own collision signal, wherein the warehouse management system can assign the collision event to an industrial truck responsible for the collision as a function of the transmitted industrial truck statuses and/or collision type probabilities and informs at least the responsible industrial truck, wherein the classification of the collision event can be carried out by the responsible industrial truck.

The industrial trucks can transmit a signal strength determined by the receiver unit of the respective industrial truck to the warehouse management system together with the collision signal or their own collision signal, whereby the warehouse management system can incorporate the signal strengths to assign the collision event to an industrial truck responsible for the collision.

In one embodiment, the warehouse management system can have a data source that provides the respective locations of the industrial trucks. For example, the warehouse management system can use the locations of the industrial trucks provided by the data source to assign an industrial truck responsible for the collision to the collision event.

A more precise localization and thus better usability of the classification of the collision event can be made possible if the classification of the collision event includes determining a collision location of the collision event, whereby the collision location can be determined depending on the status data and/or the assigned collision type. A user of the racking system and/or a warehouse management system can be notified of a collision location determined in this way, which can then be checked for stability and safety.

The collision location can be at the racking system that is monitored by the sensor unit reporting the collision event. Once it has been determined that an industrial truck has caused the collision event and, if applicable, the collision type of the collision event, the collision location can be determined in more detail. In embodiments, the collision location can be determined taking into account location information of the sensor unit on the racking system and/or within a warehouse. The collision location can be determined taking into account the mast stroke of the industrial truck at the time of the collision event. For example, when storing a load in a rack, a collision location can be located in an upper area of the rack, depending on the mast lift position on the industrial truck. If a load wheel arm collides with a racking system, the collision location can be considered to be near the floor.

Efficient utilization of the classification result can be provided by a further method step, namely that the method further comprises that a user of the industrial truck and/or a warehouse management system is informed about the collision event, such as about the classification of the collision event. For example, the user of the industrial truck and/or a warehouse management system can be informed about a collision location and/or a shock level and/or the strength of the collision event and/or other parameters of the collision event.

Efficient classification of the collision event can be achieved if the collision event is classified using at least one machine learning method, such as using at least one neural network, and/or using a status machine. In this way, the classification results can be improved. A neural network for classifying a collision event can be trained using training data comprising data sets of collision signals and status data. Each data set can additionally contain a classification type describing the collision event. In some embodiments, the training data can comprise further information, such as information generated from a training model, such as a determined strength and/or time series of measurement data for determining the strength of the collision event. After a neural network has been trained for classification, it can be configured and set up to classify collision events on the basis of the described properties.

Reliable provision of status data can be ensured if the industrial truck continuously records status data of the industrial truck, such as by a ring buffer, and makes it available for a predetermined period of time, such as the predetermined period of time being adapted to the duration of the time window of the recorded status data before and/or after the collision event. A ring buffer can also be referred to as a ring memory. A ring buffer can be a memory of fixed size, wherein when the ring buffer is full, the oldest content can be overwritten. The oldest stored status data can be overwritten when the status data is recorded.

Furthermore, the problem can be solved by a collision classification system for classifying a collision event on a racking system having at least one collision detection device which has a sensor unit, the sensor unit can comprise an acceleration sensor, and at least one industrial truck, which has a receiver unit and a control unit with a status data memory, the collision classification system being configured to carry out a method described above for classifying a collision event on a racking system.

The collision classification system has the same advantages as the method already described.

The collision classification system can comprise a warehouse management system, wherein the warehouse management system can be configured to communicate with the at least one industrial truck. A warehouse management system can enable optimum management of the warehouse, including the racking system. For example, a warehouse management system can reliably inform a user of all collision events at the at least one racking system.

### BRIEF DESCRIPTION OF THE DRAWINGS

Further features will become apparent from the description of embodiments together with the claims and the accompanying drawings. Embodiments can fulfill individual features or a combination of several features.

The embodiments are described below, without limiting the general idea of the invention, by examples of embodiments with reference to the drawings, with express reference being made to the drawings with regard to all details which are not explained in more detail in the text. The drawings show:

FIG. 1 illustrates a schematic side view of a first collision classification system with a driving collision as the collision event,

FIG. 2 illustrates a schematic side view of the first collision classification system with a second collision event during storage of a load in a rack,

FIG. 3 illustrates a schematic sketch in plan view of a second collision classification system with a driving collision with the rear of an industrial truck as a third collision event,

FIG. 4 illustrates a schematic sequence of an embodiment of a method for classifying a collision event on a racking system,

FIG. 5 illustrates a first schematic status data diagram with the driving speed of the industrial truck over time,

FIG. 6 illustrates a second schematic status data diagram showing the driving speed of the industrial truck over time,

FIG. 7 illustrates a third schematic status data diagram with the driving speed of the industrial truck over time,

FIG. 8 illustrates a fourth schematic status data diagram showing the driving speed of the industrial truck over time and the lifting speed of the industrial truck over time.

### DETAILED DESCRIPTION

In the drawings, identical or similar elements and/or parts are provided with the same reference numbers, so that they are not presented again.

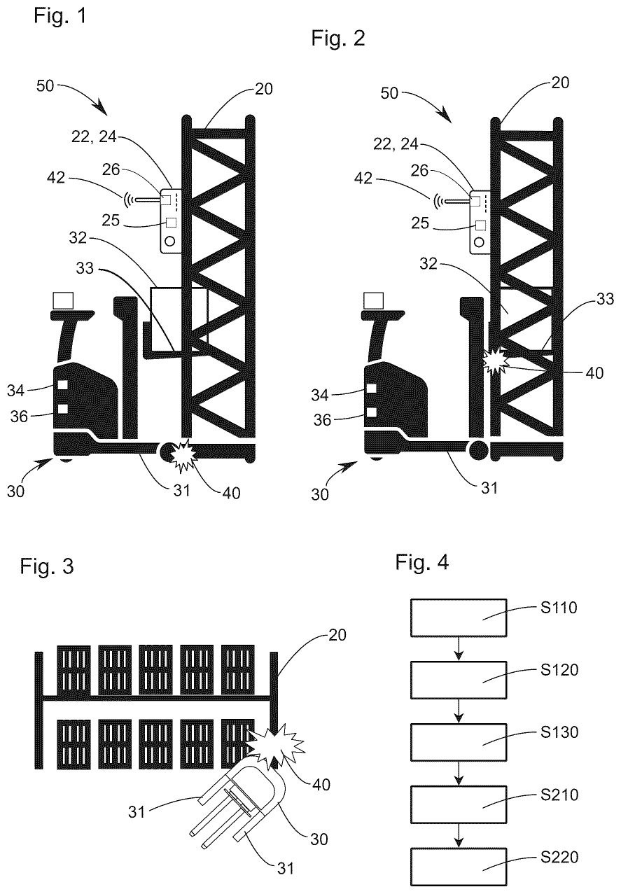

FIG. 1 shows a schematic side view of a first collision classification system 50 with a collision event 40, the event being a driving collision, i.e., a collision when approaching a rack. A collision detection device 24 comprising a processor 25 and a sensor 22 is arranged on a racking system 20. The sensor 22 can be attached and/or is attached to the racking system 20.

An industrial truck 30, which transports a load 32 on its forks 33, is located near the racking system 20. The industrial truck has a receiver 34 and a controller 36, the controller comprising hardware, such as a CPU, processor, or computer.

In the collision event 40 shown in FIG. 1, a load wheel arm 31 of the industrial truck 30 collides with the racking system 20 at the lower end of the racking system 20. The sensor 22 detects the collision event 40 and determines a strength of the collision event 40. In this exemplary embodiment, the sensor 22 comprises an acceleration sensor. The determined strength of the collision event 40 is the maximum amplitude of an acceleration measured by the acceleration sensor. This acceleration can be represented in suitable units, for example as m/s² or as g-force, i.e., in units of the acceleration due to gravity of 9.81 m/s². The determined force is compared by the sensor with a reference force, in this exemplary embodiment a reference amplitude of the acceleration.

Since the strength of the collision event 40 exceeds the reference strength in this exemplary embodiment, the processor 25 controls the sensor 22 and or a transmitter 26 connected thereto, to transmit a wireless collision signal 42, which is received by the receiver 34 of the industrial truck 30 and forwarded to the controller 36 of the industrial truck 30. There, the collision event 40 is classified.

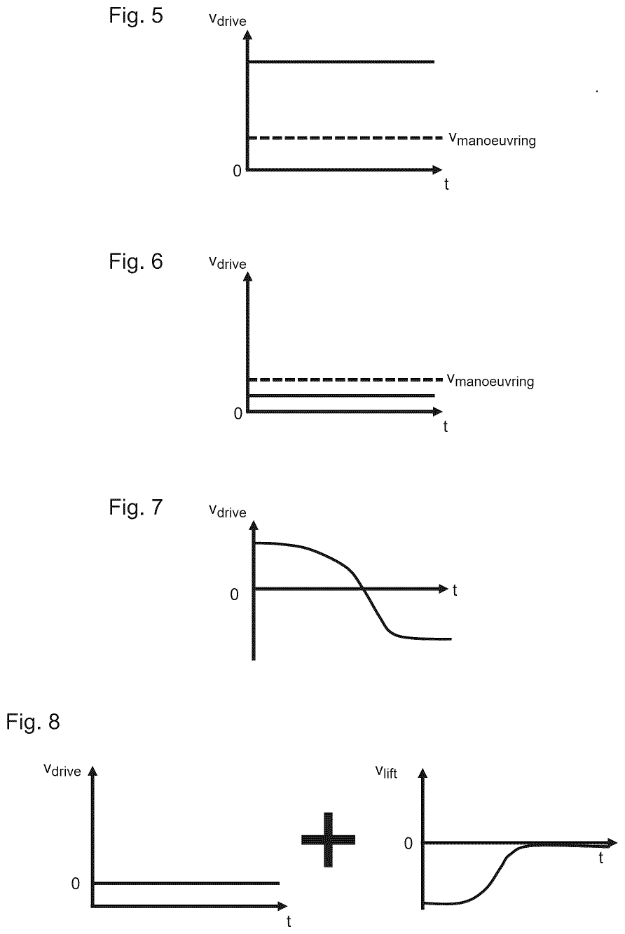

In this exemplary embodiment, the collision type list has three collision types: “industrial truck not responsible for collision”, “driving collision”, “storage of load”. In this exemplary embodiment, a collision probability between 0% and 100% or between 0 and 1 is calculated for each of the three collision types on the basis of the status data of the industrial truck 30 and the collision signal 42. Since the collision probability for “driving collision” is calculated to be the highest of the three collision types in the collision type list, this collision type is output as a classification and shown to the user of the industrial truck 30 on a display. Options for differentiating between the collision types are described below in connection with FIGS. 5 to 8.

FIG. 2 shows the first collision classification system 50, which was shown in FIG. 1, with a second collision event 40. This collision event 40 occurs when a load 32 is placed on a shelf, whereby lowering the load 32 too quickly leads to a vibration in the racking system 20. This is registered by the sensor 22 and its strength is determined. In this exemplary embodiment, the sensor 22 can be configured to determine the momentum transfer caused by the collision event 40 as the strength. The transmission of a collision signal 42 is similar to that described for FIG. 1.

In this exemplary embodiment, a collision type list with five collision types is provided. In addition to the individual collision type “industrial truck not responsible for collision”, the collision types “driving collision” and “storage collision” are each provided in “high intensity” and “low intensity”. Consequently, the collision event 40 is also classified in terms of its intensity in addition to the type of collision. This can be used, for example, to assess the urgency of maintenance and, if necessary, repair at the collision site.

FIG. 3 shows a schematic sketch in plan view of a second collision classification system 50 with a driving collision with the rear of an industrial truck 30 as a third collision event 40.

Such a collision event 40, for example classified as a “rear collision”, is indicated, for example, by a low driving speed of the industrial truck 30 and a considerable turning speed of the industrial truck 30. If the status data of the industrial truck 30 shows such a movement, a rear collision of this kind is likely, provided the industrial truck 30 is positioned near the collision location.

FIG. 4 shows a schematic sequence of an embodiment of a method for classifying a collision event 40 on a racking system 20.

In a first step, a sensor 22 arranged on a racking system 20 detects a collision event 40 between an industrial truck 30 and a racking system 20 and determines a strength of the collision event (step S110). The strength of a collision event is, for example, an acceleration, a momentum transfer and/or an energy transfer.

The determined thickness is compared with a reference thickness (step S120). In some embodiments, the determined strength is compared with several reference strengths. In this way, the sensor 22 determines an intensity of the collision event 40. If the determined strength exceeds the reference strength, the sensor 22 emits a collision signal 42 (step S130). For example, the sensor 22 transmits the result of a comparison with several reference intensities in a collision signal 42.

A receiver 34 of an industrial truck 30 receives the collision signal 42 and forwards it to a controller 36 of the industrial truck 30 (step S210). The controller 36 carries out a classification depending on the status data of the industrial truck 30 and the collision signal 42 (step S220).

In one exemplary embodiment, the receiver 34 can determine a signal strength of the collision signal 42, for example in the form of a so-called Received Signal Strength Indication (RSSI) signal of a radio connection, for example a Bluetooth Low Energy radio connection. The signal strength is forwarded to the controller 36 together with the collision signal 42, whereby the controller 36 performs the classification depending on the collision signal 42 and the signal strength. The signal strength is dependent on the distance of the industrial truck 30 to the sensor 22. This can be used to estimate collision type probability for a collision of the industrial truck 30 with the racking system 20 to be lower in the case of a low RSSI signal than in the case of a strong RSSI signal.

Possible dependencies of the classification of status data of the industrial truck 30 are shown as examples in FIGS. 5 to 8.

FIG. 5 shows a first schematic status data diagram with the driving speed v_{drive} of an industrial truck 30 over time. A driving speed is constant over the entire time window and is greater than a maneuvering speed v_{manoeuvring}. This suggests that the industrial truck 30 is moving through a logistics facility and is not in a maneuvering process. Furthermore, since changes in speed usually occur during a collision event 40, a constant speed indicates that the industrial truck 30 was not involved in a collision event 40. During classification, a course shown in FIG. 5 with a high classification type probability is assigned a collision type “industrial truck not responsible for collision”.

FIG. 6 shows a second schematic status data diagram in which, similar to FIG. 5, the driving speed v_{drive} of the industrial truck 30 is plotted against time. In this case, the driving speed is constantly below a maneuvering speed v_{manoeuvring}. This indicates that the industrial truck 30 has performed a maneuvering movement, for example to position itself in front of a racking system 20 for loading or unloading. During such an operation, collisions between the industrial truck 30 and the racking system 20 are not unlikely, and a slight collision, such as touching, does not necessarily lead to a significant change in speed. Accordingly, status data such as that shown in FIG. 6 is an indication that a collision could have been triggered by the industrial truck 30 in question. If necessary, further vehicle status data must be evaluated in order to arrive at a sufficiently high collision type probability.

In FIG. 7, a third schematic status data diagram shows a driving speed v_{drive}, which has a change of sign in the relevant time window for which status data is provided. This is characteristic of a collision between industrial truck 30 and racking system 20 during a driving collision, as the industrial truck 30 usually reverses after a collision event in order to correct the travel path. Accordingly, the progression of the status data shown in FIG. 7 correlates with an increased collision type probability for collision types for a driving collision, such as when an industrial truck 30 approaches a racking system 20 for loading or unloading.

The status data shown in FIGS. 5 to 7 are each recorded in a time window within which the time of the collision event 40 is located. In FIG. 7, for example, the time of the collision event 40 is when the driving speed reaches the value 0 (zero).

In other embodiments not shown, the time window in which the status data is or are recorded can be exclusively before and during the collision event 40, so that status data from points in time after the collision event 40 are not taken into account. In further embodiments, instantaneous status data at the time of the collision event is taken into account for the classification of the collision type. The time restriction of a time window for the status data reduces the data basis for the classification, but this reduces the computational effort so that a classification is available more quickly.

Finally, a fourth case study is shown in FIG. 8 using schematic status data diagrams, where the driving speed v_{drive} on the one hand and the lifting speed v_{lift} on the other are plotted over time. The driving speed v_{drive} is constantly zero or almost zero, so that the industrial truck 30 does not move. The lifting speed v_{lift} is negative at the beginning of the time window and has a relatively high value, i.e. a load is set down or lowered at this speed. The amount of the lifting speed decreases over time until it is almost zero. Consequently, the load is not lowered any further and is also not lifted. Accordingly, this is a typical diagram for the progression of a lifting speed when lowering a load. Together with a stationary industrial truck 30, where the driving speed is zero, this indicates that a load 32 is being set down by the industrial truck 30.

In one embodiment, the classification of the collision event 40 includes determining a collision location of the collision event 40. For example, a collision type “load set down in rack” is determined for the status data in FIG. 8. In addition to this, the controller 36 of the industrial truck 30 evaluates a mast stroke of the industrial truck 30 in a time window around the collision event 40. The height at which the load 32 is likely to have collided with the racking system 20 can be determined from the mast stroke. This information is transmitted to a user of the industrial truck 30 and/or a warehouse management system so that the probable collision location can be specifically checked during a subsequent inspection

A further analysis of status data, not shown, is carried out, for example, by measuring an angular speed of rotation. If the angular speed of rotation is high and the driving speed is low, this indicates a collision of the industrial truck 30 with a racking system 20 with a rear of the industrial truck 30 from a rotational movement, whereby an orientation of the industrial truck 30 relative to the racking system 20 can also be added.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SYMBOLS

20 Racking system
22 Sensor
24 Collision detection device
25 Processor
26 Transmitter
30 Industrial truck
31 Load wheel arm
32 Load
33 Fork
34 Receiver
36 Controller
40 Collision event
42 Collision signal
50 Collision classification system
S110 Detecting of a collision event and determining a strength of the collision event
S120 Comparing the determined thickness with a reference thickness
S130 Transmitting a collision signal assigned to the collision event
S210 Receiving the collision signal and forwarding it to a controller
S220 Performing a classification of the collision event
v_{Drive} Driving speed
v_{manoeuvring} Maneuvering speed
v_{Lift} Lifting speed
t time

1. A method of classifying a collision event on a racking system, the method comprising:
detecting the collision event between an industrial truck and the racking system using a sensor arranged on the racking system and determining a strength of the collision event, comparing the determined strength with a reference strength and emitting a collision signal associated with the collision event if the determined strength exceeds the reference strength;
transmitting the collision signal to a receiver of the industrial truck and the receiver forwarding the collision signal to a controller of the industrial truck, the controller classifying the collision event as a function of status data of the industrial truck and of the collision signal,
wherein the classifying of the collision event comprises assigning a collision type from a collision type list, wherein the collision type list comprises at least one collision type for which the collision event is not assigned to the industrial truck and at least one collision type for which the collision event is assigned to the industrial truck.

2. The method according to claim 1, wherein the collision list comprises at least two different collision types for which the collision event is assigned to the industrial truck.

3. The method according to claim 1, wherein the assigning of the collision type comprises determining at least one collision type probability, which indicates a probability that the collision event can be unambiguously assigned to a specific collision type and determining a separate collision type probability for each collision type.

4. The method according to claim 1, wherein the status data of the industrial truck comprise one or more of a driving speed of the industrial truck, a lifting speed of the industrial truck, and an acceleration measured by an acceleration sensor mounted on the industrial truck.

5. The method according to any claim 1, wherein the status data is recorded in a time window and the time window comprises the time of the collision event and one or more of a time period before and after the time of the collision event.

6. The method according to claim 1, wherein, for classifying of the collision event, an industrial truck status at the time of the collision event is determined as a function of the status data.

7. The method according to claim 6, wherein one or more of the at least one collision type probability and the assigned collision type are determined as a function of the determined industrial truck status.

8. The method according to claim 1, wherein assigning of the collision type comprises successively determining, whether the collision event is assigned to the industrial truck, and a collision type is assigned to the collision event.

9. The method according to claim 1, further comprising using one or more of a directly measured or derived physical or composite quantity as the determined strength of the collision event and the sensor unit compares the determined strength of the collision event with at least two reference strengths.

10. The method according to claim 9, wherein the directly measured or derived physical or composite quantity comprises one or more of a maximum acceleration, an amplitude measured by an acceleration sensor, a momentum transfer and an energy transfer.

11. The method according to claim 1, wherein the collision signal comprises one or more of the determined strength of the collision event and a time series of measurement data recorded by the sensor for determining the strength of the collision event.

12. The method according to claim 11, wherein the time series of measurement data recorded by the sensor comprises a time series of accelerations of the collision event, wherein the time series contains the time of the collision event, wherein, one or more of the strength of the collision event and the time series of measurement data are evaluated for classifying the collision event.

13. The method according to claim 1, wherein the classification of the collision event comprises a determination of a shock level of the collision event as an indicator of the impact on the integrity of the racking system.

14. The method according to claim 1, wherein the receiver determines a signal strength of the collision signal and the signal strength is evaluated for classifying the collision event, wherein the collision type probability is determined to be greater, the greater the signal strength.

15. The method according to claim 1, wherein at least two industrial trucks receive the collision signal by the receiver and, depending on the respective status data, each determine one or more of an industrial truck status and at least one collision type probability and transmit them together with the collision signal or their own collision signal to a warehouse management system, wherein the warehouse management system assigns the collision event to an industrial truck responsible for the collision as a function of one or more of the transmitted industrial truck statuses and collision type probabilities and informs at least the responsible industrial truck, wherein the classification of the collision event is carried out by the responsible industrial truck.

16. The method according to claim 1, wherein the classifying of the collision event comprises that a collision location of the collision event is determined.

17. The method according to claim 1, wherein further comprising informing one or more of a user of the industrial truck and a warehouse management system about the collision event.

18. The method according to claim 17, wherein the informing informs about the classification of the collision event.

19. The method according to claim 1, wherein the classification of the collision event is carried out by at least one machine learning method by one or more of at least one neural network and by a status machine.

20. The method according to claim 1, wherein the industrial truck records status data of the industrial truck continuously, and makes the recorded status data available for a predetermined period of time, the predetermined period of time being adapted to one or more of the duration of the time window of the recorded status data before and after the collision event.

21. A collision classification system for classifying a collision event on a racking system, the classification system comprising:
at least one collision detection device having a processor and a sensor, and
at least one industrial truck having a receiver and a controller with a status data memory, the processor of the collision detection device being configured to:
detect a collision event between the industrial truck and the racking system using the sensor arranged on the racking system and determining a strength of the collision event, comparing the determined strength with a reference strength and emitting a collision signal associated with the collision event if the determined strength exceeds the reference strength; and
transmit the collision signal to the receiver of the industrial truck,
the receiver of the industrial truck being configured to forward the collision signal to the controller of the industrial truck, the controller of the industrial truck being configured to classify the collision event as a function of status data of the industrial truck and of the collision signal;
wherein the classifying of the collision event comprises assigning a collision type from a collision type list, wherein the collision type list comprises at least one collision type for which the collision event is not assigned to the industrial truck and at least one collision type for which the collision event is assigned to the industrial truck.

22. The collision classification system according to claim 21, wherein the collision classification system comprises a warehouse management system, wherein the warehouse management system is configured to communicate with the at least one industrial truck.
